(19) United States
(12) Patent Application Publication
(10) Pub. No.: US 2024/0155585 A1
(43) Pub. Date: May 9, 2024

(54) DESIGN ON TXRU CARRIER SWITCH FOR B5G/6G

(71) Applicant: MEDIATEK INC., Hsinchu City (TW)

(72) Inventors: Yi-Ju Liao, Hsinchu City (TW); Pei-Kai Liao, Hsinchu City (TW); Chi-Hsuan Hsieh, Hsinchu City (TW); Wei-De Wu, Hsinchu City (TW)

(21) Appl. No.: 18/500,043

(22) Filed: Nov. 1, 2023

Related U.S. Application Data
(60) Provisional application No. 63/382,304, filed on Nov. 4, 2022.
(60) Provisional application No. 63/387,999, filed on Dec. 19, 2022.

(51) Int. Cl. H04W 72/0453; H04W 72/232

(52) U.S. Cl. CPC H04W 72/0453; H04W 72/232

(57) ABSTRACT

Apparatus and methods are provided for TxRU carrier switch. In one embodiment, the UE is configured with an anchor carrier in an anchor cell and one or more secondary carriers. In one embodiment, the TxRU carrier switch is configured as supplementary uplink (SUL)-based carrier switch with supplementary carriers or configured as a CA-based carrier switch with supplementary cells. In one embodiment, the one or more secondary carriers are supplementary carriers of the anchor cell, and wherein the anchor carrier is TDD carrier or frequency division duplex (FDD) carrier, and wherein the supplementary carrier is configured as a TDD carrier, a FDD carrier, a supplementary uplink carrier (SUL), or a supplementary downlink carrier (SDL). In another embodiment, the one or more secondary carriers are supplementary cells different from the anchor cell, and wherein the supplementary cells are configured with MAC control element (CE).

### CROSS REFERENCE TO RELATED APPLICATIONS

This application claims priority under 35 U.S.C. §119 from U.S. Provisional Application No. 63/382,304 entitled “Design on Inter-band Carrier Switch in B5G/6G,” filed on Nov. 4, 2022. This application claims priority under 35 U.S.C. §119 from U.S. Provisional Application No. 63/387,999 entitled “Design on TxRU Carrier Switch for B5G/6G,” filed on Dec. 19, 2022. The disclosure of each of the foregoing documents is incorporated herein by reference.

### TECHNICAL FIELD

The disclosed embodiments relate generally to wireless communication, and, more particularly, TxRU carrier switch for B5G/6G.

### BACKGROUND

Mobil communication standards have been developed. into a new era of beyond 5G (B5G) and 6G. These next-generation wireless networks promise unprecedented speeds, ultra-low latency, and support for a multitude of devices, ushering in an era of connectivity that will revolutionize industries and daily life. In one particular are, the B5G/6G will enable the seamless integration of lightweight, energy-efficient devices into the fabric of our connected world, supporting a wide array of applications that are poised to transform industries and enhance our daily lives.

Reduced capability mobile devices, often referred to as “thin clients” or “lightweight terminals,” are a category of wireless devices that prioritize minimal power consumption, compact form factors, and reduced processing capabilities. The RedCap mobile devices are equipped with transceiver units (TxRU), which includes a transmitter unit (TxU) and a receiver unit (RxU), with limited bandwidth capacity. The TxRU does not support dbwnlink (DL) or uplink (UL) carrier aggregation. These devices encompass a wide range of applications, from Internet of Things (IoT) sensors to wearables, remote control units, and even certain types of augmented reality glasses. The wireless system designed to support these devices in the context of B5G and 6G networks is a topic of considerable importance.

Improvements and enhancements are required for carrier switch design for the RedCap mobile devices.

### SUMMARY

Apparatus and methods are provided for TxRU carrier switch. In one embodiment, the UE is configured with an anchor carrier in an anchor cell and one or more secondary carriers, determines a switch pattern for a data transceiving on the anchor carrier and the one or more secondary carriers, and selects transmitting and receiving resources based on the switch pattern for the data transceiving. The TxRU carrier switch is configured as an SUL-based carrier switch with supplementary carriers or configured as a CA-based carrier switch with supplementary cells. In one embodiment, the one or more secondary carriers are supplementary carriers of the anchor cell, and wherein the anchor carrier is TDD carrier or frequency division duplex (FDD) carrier, and wherein the supplementary carrier is configured as a TDD carrier, a FDD carrier, a supplementary uplink carrier (SUL), or a supplementary downlink carrier (SDL). In another embodiment, the one or more secondary carriers are supplementary cells different from the anchor cell, and wherein the supplementary cells are activated with MAC control element (CE). In one embodiment, the switch pattern is semi-static, and wherein the semi-static switch pattern is configured by a UE-specific radio resource control (RRC) signaling for each carrier, derived from a time divisional duplex (TDD) configuration for each carrier, or determined by a TxRU hopping formula. In another embodiment, the switch pattern is dynamically configured through downlink control information (DCI). In one embodiment, the switch pattern is configured in a hybrid mode for the TxU and the RxU with a combination of a semi-static switch pattern and a dynamic switch pattern. In one embodiment, one or more switch gaps along with each TxU or RxU carrier switch based on the switch pattern, wherein there is no data transceiving during each switch gap. In one embodiment, TxRU switch gap locations are configured separately for the TxU and the RxU. In another embodiment, joint switch gap locations are configured for the TxU and the RxU, and wherein each carrier is configured with joint switch pattern and gap location in slot or symbol level, or a combination of slot and symbol level.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports TxRU carrier switch for B5G/6G in accordance with embodiments of the current invention.

FIG. 2 is a simplified block diagram of a gNB and a UE in accordance with embodiments of the present invention.

FIG. 3 illustrates exemplary diagrams for different configurations for TxRU carrier switch with exemplary secondary carriers in accordance with embodiments of the current inventions.

FIG. 4 illustrates exemplary top-level diagrams for SUL-based and CA-based carrier switch and UE capability configurations in accordance with embodiments of the current invention.

FIG. 5 illustrates exemplary diagrams for switch gap configurations for TxRU carrier switch in accordance with embodiments of the current invention.

FIG. 6 illustrates exemplary diagrams for carrier pattern configurations for TxRU carrier switch in accordance with embodiments of the current invention.

FIG. 7 illustrates exemplary diagrams for BWP configurations for TxRU carrier switch in accordance with embodiments of the current invention.

FIG. 8 illustrates exemplary diagrams for RRC configurations for SUL-based and CA-based carrier switch in accordance with embodiments of the current invention.

FIG. 9 illustrates exemplary diagrams for CSI acquisition for SUL-based and CA-based carrier switch in accordance with embodiments of the current invention.

FIG. 10 illustrates exemplary diagrams for HARQ configuration for SUL-based and CA-based carrier switch in accordance with embodiments of the current invention.

FIG. 11 illustrates exemplary diagrams for UL power control for SUL-based and CA-based carrier switch in accordance with embodiments of the current invention.

FIG. 12 illustrates an exemplary flow chart for the TxRU carrier switch in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system. Also please note that even some embodiments are described in 5G context, the invention can be applied to 6G or other radio access technology.

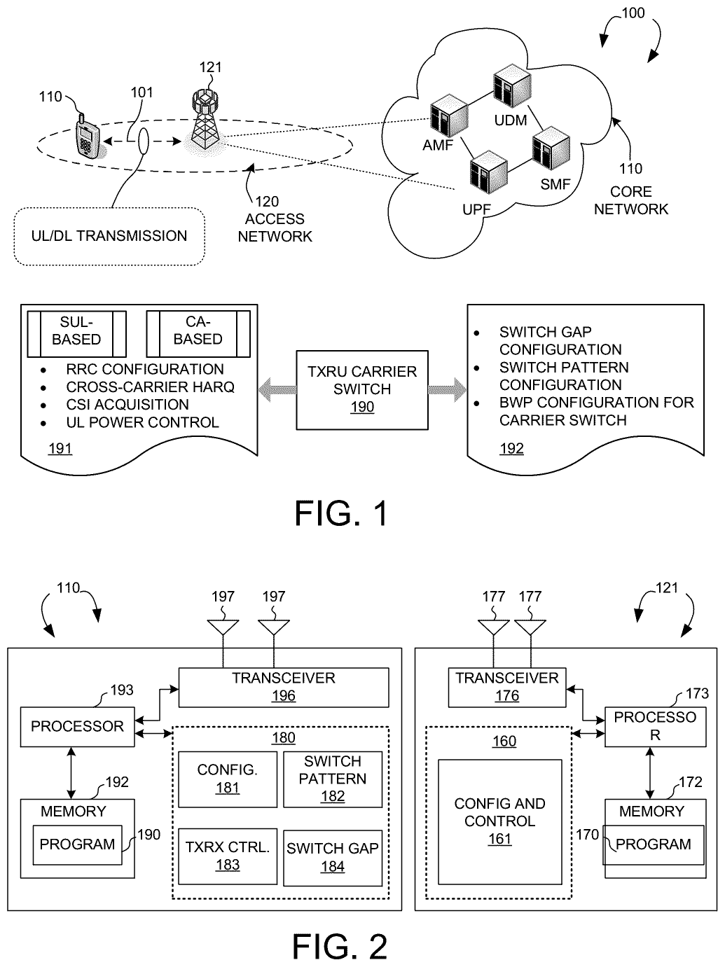

FIG. 1 is a schematic system diagram illustrating an exemplary wireless network that supports TxRU carrier switch for B5G/6G in accordance with embodiments of the current invention. The B5G/6G network 100 includes a user equipment (UE) 110 communicatively connected to a gNB 121 operating of an access network 120 which provides radio access using a Radio Access Technology (RAT) (e.g., the B5G/6G technology). The access network 120 is connected to a core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The gNB 121 may provide communication coverage for a geographic coverage area in which communications with the UE 110 is supported via a communication link 101. The communication link 101 shown in the B5G/6G network 100 may include UL transmissions from the UE 110 to the gNB 121 (e.g., on the Physical Uplink Control Channel (PUCCH) or Physical Uplink Shared Channel (PUSCH)) or downlink (DL) transmissions from the gNB 121 to the UE 110 (e.g., on the Physical Downlink Control Channel (PDCCH) or Physical Downlink Shared Channel (PDSCH)).

The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication. In one novel aspect 190, UE 110, being a RedCap device that does not support carrier aggregation, is configured with one or more secondary carriers, and performs TxRU carrier switch. In one set of embodiments 191, the carrier switch is supplementary UL (SUL)-based or carrier aggregation (CA)-based framework, which includes TxRU carrier switch designs of RRC configuration, cross-carrier HARQ, channel state information (CSI) acquisition, and UL power control. In another set of embodiments 192, switch gap configuration, switch pattern configuration and bandwidth part (BWP) configuration for TxRU carrier switch are provided.

FIG. 2 is a simplified block diagram of a gNB 121 and a UE 110 in accordance with embodiments of the present invention. For the gNB 121, antennas 177 transmit and receive radio signal under MIMO network. A radio frequency (RF) transceiver module 176, coupled with the antennas, receives RF signals from the antennas, converts them to baseband signals and sends them to processor 173. RF transceiver 176 also converts received baseband signals from the processor 173, converts them to RF signals, and sends out to antennas 177. Processor 173 processes the received baseband signals and invokes different functional modules and circuits to perform features in the gNB 121. Memory 172 stores program instructions and data 170 to control the operations of the gNB 121.

Similarly, for the UE 110, antennae 197 transmit and receive RF signal under MIMO network. RF transceiver module 196, coupled with the antennas, receives RF signals from the antennas, converts them to baseband signals and sends them to processor 193. The RF transceiver 196 also converts received baseband signals from the processor 193, converts them to RF signals, and sends out to antennas 197. Processor 193 processes the received baseband signals and invokes different functional modules and circuits to perform features in the UE 110. Memory 192 stores program instructions and data 190 to control the operations of the UE 110. Although a specific number of the antennas 177 and 197 are depicted in FIG. 2, it is contemplated that any number of the antennas 177 and 197 may be introduced under the MIMO network.

The gNB 121 and the UE 110 also include several functional modules and circuits that can be implemented and configured to perform embodiments of the present invention. In the example of FIG. 2, the gNB 121 includes a set of control functional modules and circuit 160. Configuration and control circuit 161 provides different parameters to configure and control UE 110. UE 110 includes a set of control functional modules and circuit 180. Configuration module 181 configures one or more secondary carriers for the UE, wherein the UE establishes connection with the wireless network on an anchor carrier of an anchor cell. Switch pattern module 182 determines a switch pattern for a data transceiving on the anchor carrier and the one or more secondary carriers. In one embodiment, the UE is a reduced capability (RedCap) UE that the TxU transmits on one carrier at a time and the RxU receives on one carrier at a time. Transceiving controller 183 selects transmitting and receiving resources based on the switch pattern for the data transceiving. Switch gap module 184 configures one or more switch gaps along with each TxU or RxU carrier switch based on the switch pattern, wherein there is no data transceiving during each switch gap.

Note that the different functional modules and circuits can be implemented and configured by software, firmware, hardware, and any combination thereof. The function modules and circuits, when executed by the processors 193 and 173 (e.g., via executing program codes 190 and 170), allow the gNB 121 and the UE 110 to perform embodiments of the present invention.

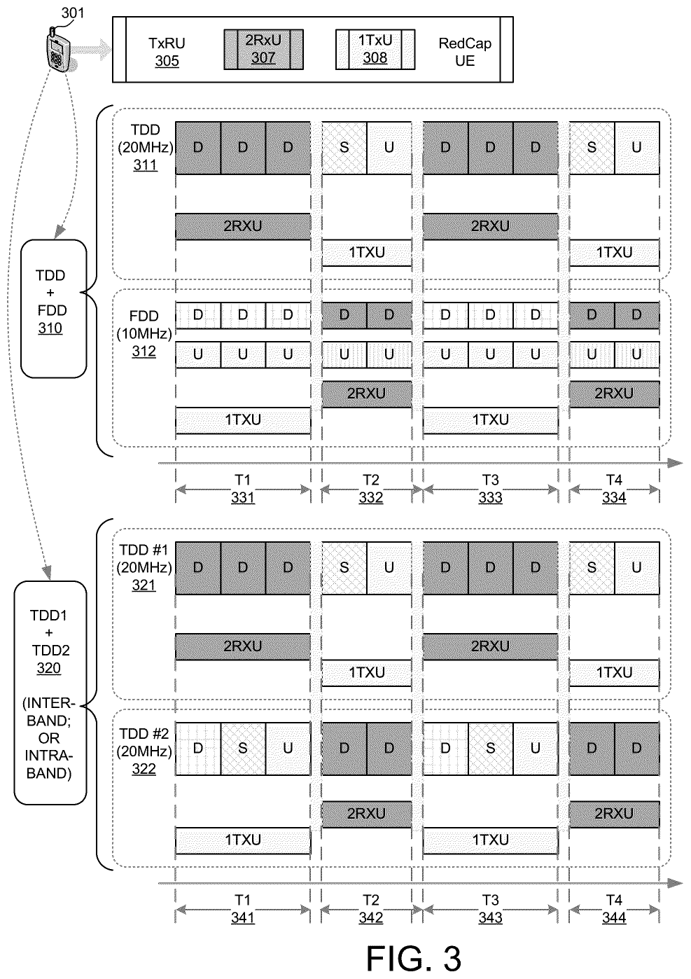

FIG. 3 illustrates exemplary diagrams for different configurations for TxRU carrier switch with exemplary secondary carriers in accordance with embodiments of the current inventions. In one novel aspect, one or more secondary carriers are configured for the UE, which accesses the wireless network on an anchor carrier in an anchor cell. UE 301, being a RedCap, performs TxRU carrier switch to improve DL/UL data latency or coverage. It also provides data offloading for the RedCap UE that does not support DL/UL CA. UE 301 has TxRU 305. As an example, TxRU 305 is configured with a TxU (1TxU) and a RxU (2RxU). The RedCap UE cannot transmit data simultaneously in more than one carrier/cell, nor can the RedCap UE receive data simultaneously in more than one carrier/cell. The TxRU carrier switch enables the RedCap UE to transmit on one carrier and receive on another carrier without handover interruption for carrier switch.

In one embodiment 310, the carrier switch is configured with a combination of frequency division duplex (FDD) carrier and time division duplex (TDD) carrier. For example, the first carrier is TDD 311, with bandwidth of 20Mhz. TDD 311 is configured downlink (D), uplink (U), special (S) frames. FDD 312, with downlink (D) bandwidth of 10 Mhz, and uplink (U) bandwidth of 10 Mhz is configured on another carrier. In one novel aspect, the UE is configured with an anchor carrier of either the TDD 311 or FDD 312. The secondary carrier is configured for TxRU carrier switch. As an example, at T1 331, RxU is scheduled for TDD carrier 311 and TxU is scheduled for FDD carrier 312. Similarly, at T2 332, TxU is scheduled for TDD carrier 311 and RxU is scheduled for FDD carrier 312; at T3 333, RxU is scheduled for TDD carrier 311 and TxU is scheduled for FDD carrier 312; and at T4 TxU is scheduled for TDD carrier 311 and RxU is scheduled for FDD carrier 312. The FDD and TDD combination configuration for the TxRU carrier switch achieves coverage improvements and can be used for data offloading. In a testing environment, the FDD and TDD combination TxRU carrier switch improves peak data rate for DL by 19% and for UL by 33%, assuming 210 μs switch delay.

In other embodiments as shown in 320, multiple TDD carriers are used for TxRU carrier switch. A first carrier with TDD#1 321 and a second carrier with TDD#2 322 are configured for the UE. As an example, at T1 341, RxU is scheduled for TDD#1 carrier 321 and TxU is scheduled for TDD#2 carrier 322. Similarly, at T2 342, TxU is scheduled for TDD#1 carrier 321 and RxU is scheduled for TDD#2 carrier 322; at T3 343, RxU is scheduled for TDD#1 carrier 321 and TxU is scheduled for TDD#2 carrier 322; and at T4 TxU is scheduled for TDD#1 carrier 321 and RxU is scheduled for TDD#2 carrier 322. In one embodiment, the multiple TDD carrier switch is an inter-band carrier switch. The intra-band multiple-TDD carrier switch is used for data offloading. In another embodiment, the multiple TDD carrier switch is an inter-band carrier switch. The inter-band multiple-TDD carrier switch improves DL/UL data latency by complementary TDD configuration in two carries. In a testing environment, the inter-band multiple-TDD carrier switch improves peak data rate for DL by 38% and for UL by 58%, assuming 210 μs switch delay.

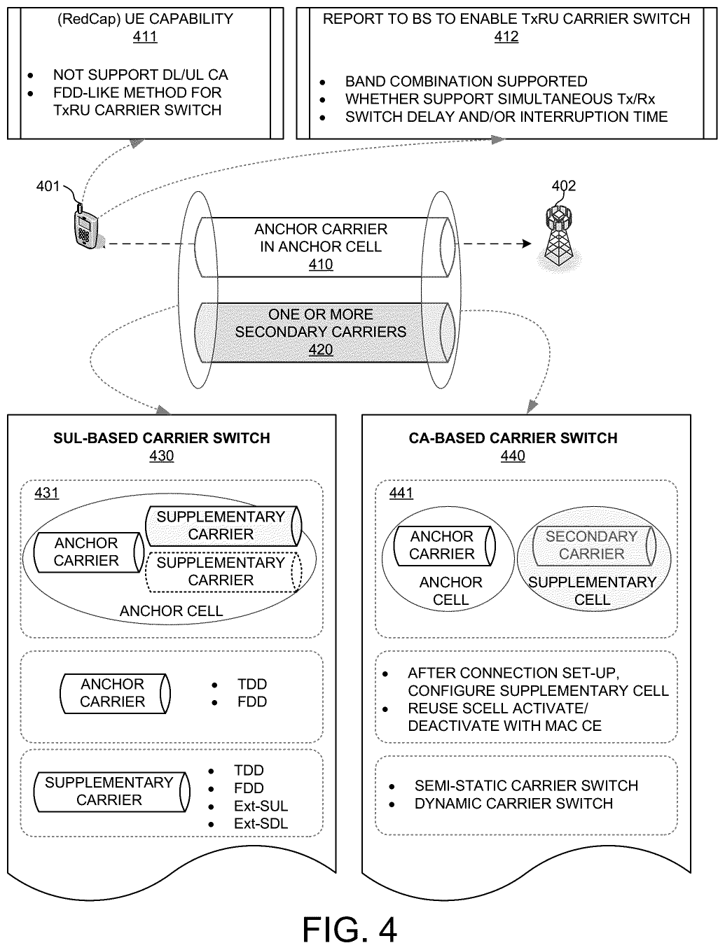

FIG. 4 illustrates exemplary top-level diagrams for SUL-based and CA-based carrier switch and UE capability configurations in accordance with embodiments of the current invention. UE 401 is a RedCap UE established connection with gNB 402 in the wireless network through anchor carrier of anchor cell 410. In one novel aspect 420, one or more secondary carriers are configured for UE 401. In one embodiment 411, UE 401 is a RedCap UE, which does not support DL/UL carrier aggregation operation. In one embodiment, the FDD-like implementation is used to realize the TxRU carrier switch. In one embodiment 412, one or more elements of UE capability are reported to the base station/gNB to enable the TxRU carrier switch. The one or more UE capability elements include UE capability report on what band combination for TxRU carrier switch can be supported; UE capability report on whether to support simultaneous Tx/Rx for a band combination; and UE capability report on the corresponding switch delay and/or interruption time. In one embodiment, there is no switch gap and/or interruption if the UE supports additional hardware path for the other carrier/cell.

In one embodiment 430, the TxRU carrier switch is the SUL-based carrier switch. In one embodiment 431, UE 401 connected with gNB 402 on anchor carrier of the anchor cell. One or more supplementary carriers associated with the anchor cell are configured for TxRU carrier switch. In one embodiment, the anchor carrier for the SUL-based framework are either TDD or FDD carriers. The supplementary carriers are configured as one type including a TDD carrier, a FDD carrier, a SUL carrier, or a supplementary downlink (SDL) carrier.

In one embodiment 440, CA-based TxRU carrier switch is configured. In one embodiment 441, UE 401 connected with gNB 402 with anchor carrier of the anchor cell. One or more supplementary cells, which are different from the anchor cell, are configured as the secondary carrier. In one embodiment, after the connection set-up on the anchor cell with the anchor carrier, UE 401 is additionally configured with one or more supplementary cells. The setup of the supplementary cells re-uses the SCell activation/deactivation procedures via MAC CE. In another embodiment, semi-static or dynamic carrier switches are configured for intra and/or inter-band carrier switch.

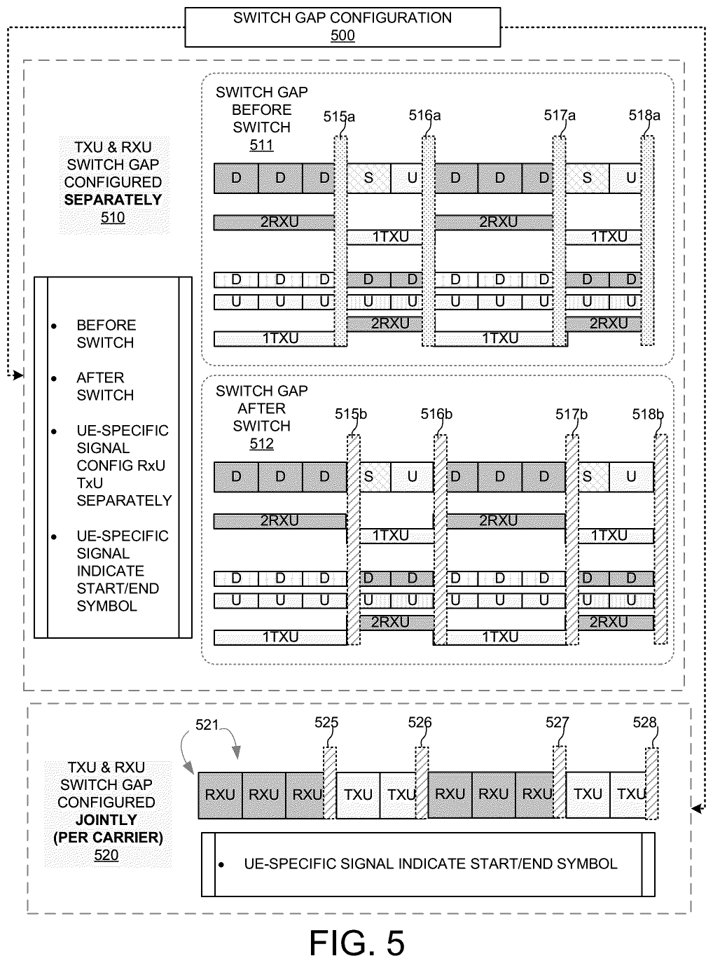

FIG. 5 illustrates exemplary diagrams for switch gap configurations for TxRU carrier switch in accordance with embodiments of the current invention. In one embodiment 500, switch gaps are configured for the TxRU carrier switch. The UE is not expected to receive nor to transmit data on any of the anchor and secondary carriers inside the switch gap/during the interruption time.

In one embodiment 510, TxU and RxU switch pattern and switch gaps/switch gap locations are configured separately. In one embodiment 511, switch gaps, such as switch gaps 515a, 516a, 517a, and 518a, are located on the carrier/cell where the corresponding TxU or the RxU is equipped before switch. In another embodiment 512, switch gaps, such as switch gaps 515b, 516b, 517b, and 518b, are located on the carrier/cell that the corresponding TxU or the RxU is switched to. In yet another embodiment, the UE-specific signaling is used to configure whether the switch gap is before the switch (511) or after the switch (512). In one embodiment, the UE-specific signaling further indicates the starting symbol and/or the ending symbol of the corresponding switch gap and/or a switch gap length.

In another embodiment 520, joint TxRU switch pattern and switch gap (location) are configured. In one embodiment, as illustrated in diagram 521, the joint switch gap configuration is a slot or symbol level configuration indicating available RxU, TxU and switch gap location, including switch gaps 525, 526, 527, and 528.

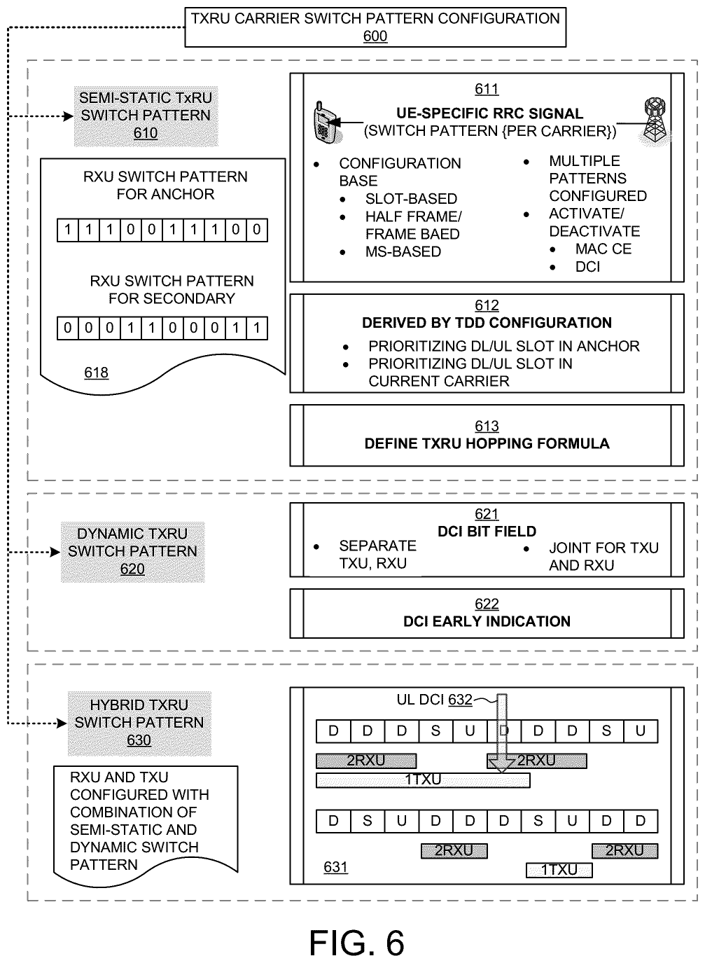

FIG. 6 illustrates exemplary diagrams for carrier pattern configurations for TxRU carrier switch in accordance with embodiments of the current invention. In one embodiment 600, TxRU carrier switch patterns are configured. In one embodiment 610, semi-static TxRU carrier switch is configured. With the semi-static TxRU switch pattern, the RxU is switched based on semi-static pattern (or the TDM-pattern). In one embodiment 611, UE-specific RRS signaling is used to configure the semi-static switch pattern for each carrier. The base station configures one or more switch patterns for each carrier. If multiple switch patterns are configured, the switch pattern can be activated or deactivated or changed by MAC CE and/or DCI signaling. The semi-static switch pattern configuration is slot-based configuration, which is preferred for data latency improvement, or half frame/frame-based configuration preferred for data offloading, or ms-based pattern switch. For the semi-static pattern switch, the TxU is switched based on a semi-static pattern as well. The switch pattern for the TxU is either the same or different from the RxU semi-static switch pattern. In another embodiment 612, the semi-static switch pattern is derived by the TDD configuration. For example, the UE compares TDD configuration on two carriers and determines when to switch RxU and/or TxU based on the DL/UL slot configured by the TDD configurations. Additional handling is required for intra-band switch. Therefore, the intra-band and inter-band semi-static switch pattern derived from the TDD configuration does not share a unified framework. In one embodiment, if anchor carrier and the secondary/supplementary carrier have overlapped DL/UL slot, additional handling is needed to determine the carrier with available TxRU. In one embodiment, TxRU carrier is determined by prioritizing DL/UL slot in the anchor carrier/cell. In another embodiment, the carrier is determined by prioritizing the DL/UL slot in the current carrier/cell. In yet another embodiment 613 for the semi-static switch pattern, a TxRU hopping formula is used to derive the switch pattern. The hopping formula procedure requires no additional RRC signaling overhead but is more complicated and hard to guarantee available DL/UL slots in switched carrier. An exemplary semi-static TxRU switch pattern 618 is illustrated. The semi-static switch pattern is configured with a bit-map-like configuration for each carrier, including the exemplary RxU switch pattern for the anchor carrier and the RxU switch pattern for the secondary carrier. “1” indicates available RxU (or TxU), and “0” indicates no RxU (or TxU) available on that carrier. When the bit toggles in the next position, carrier switch occurs.

In another embodiment 620, dynamic TxRU carrier switch is configured. In one embodiment 621, a DCI bit field in scheduling DCI format, such as 0_1, 1_1, are used to indicate whether the TxRU is switched and where to switch to. In one embodiment, RxU and TxU are configured separately by the DCI field. In another embodiment, joint RxU and TxU are configured jointly. There is no cross-carrier scheduling. The UE continues data reception or transmission on the current carrier before the TxRU switch. In another embodiment 622, early indication configuration is used for the switch pattern configuration. The DCI indicates TxRU switch in a future time slot/after a time duration. For example, TxRU switch is configured to be at slot N+Y, wherein N is the current slot index receiving the DCI indication and Y is an additional duration. In one embodiment, the UE reports its required time length (of Y) to the network. The dynamic TxU switch avoids unnecessary switch gap if the TDD configuration on two carriers is not completely complementary.

In yet another embodiment 630, a hybrid TxRU carrier switch is configured. The hybrid TxRU configures the switch pattern in a combination of the semi-static switch pattern and the dynamic switch pattern. In an exemplary diagram 631 illustrates a semi-static RxU switch pattern with a dynamic switch pattern for TxU. As illustrated, the RxU are scheduled based on the TDD configuration. At step 632, the UE receives UL DCI, which dynamically configures the TxU.

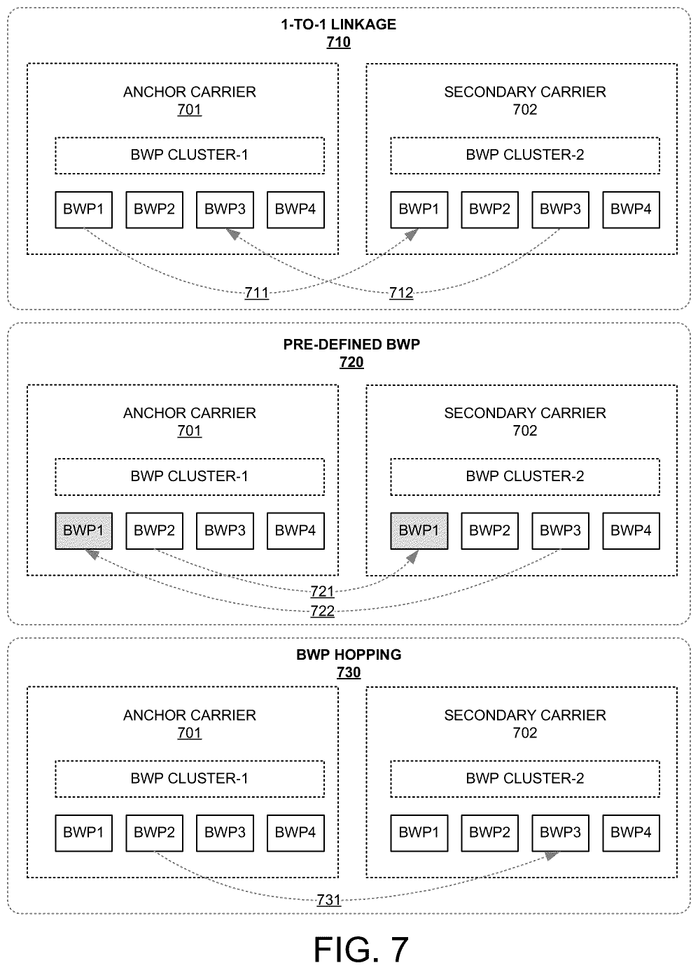

FIG. 7 illustrates exemplary diagrams for BWP configurations for TxRU carrier switch in accordance with embodiments of the current invention. When multiple BWP are configured for one or more carrier used for the TxRU carrier switch, there exists BWP ambiguity. An exemplary anchor carrier 701 is configured with BWP cluster-1 with BWP1, BWP2, BWP3, and BWP4. Similarly, a secondary carrier 702 is configured with BWP cluster-2 with BWP1, BWP2, BWP3, and BWP4. In one embodiment 710, 1-to-1 BWP linkage is used for the TxRU carrier switch. When the TxRU carrier switch happens, the BWP with the same ID is active in switched carrier. For example (711), when switching from anchor carrier 701 on BWP1 to secondary carrier 702, the UE switches to BWP1 of secondary carrier 702, which has the same BWP ID. In another example 712, if the UE is on secondary carrier 702 with BWP3, the UE switches to anchor carrier 701 on BWP3, which has the same BWP ID. In another embodiment 720, the BWP selection is based on predefined BWP. The UE always switches to the BWP with the lowest index or the highest index of the carrier. For example (721), if initially the UE is on BWP2 of anchor carrier 702, the UE switches to BWP1 of secondary carrier 702, since BWP1 is the lowest index of secondary carrier 702. Similarly (722), if the UE is initially on BWP3 of secondary carrier 702, the UE switches to BWP1 of anchor carrier 701 since BWP1 is the lowest index of anchor carrier 701. In yet another embodiment 730, BWP hopping is configured for the BWP selection for the TxRU carrier switch. In one embodiment, the hopping is defined by time_idx mod BWP_num of switched carrier. For example (730), the UE on BWP2 of anchor carrier 701 switches to BWP3 of secondary carrier 702 based on the BWP hopping.

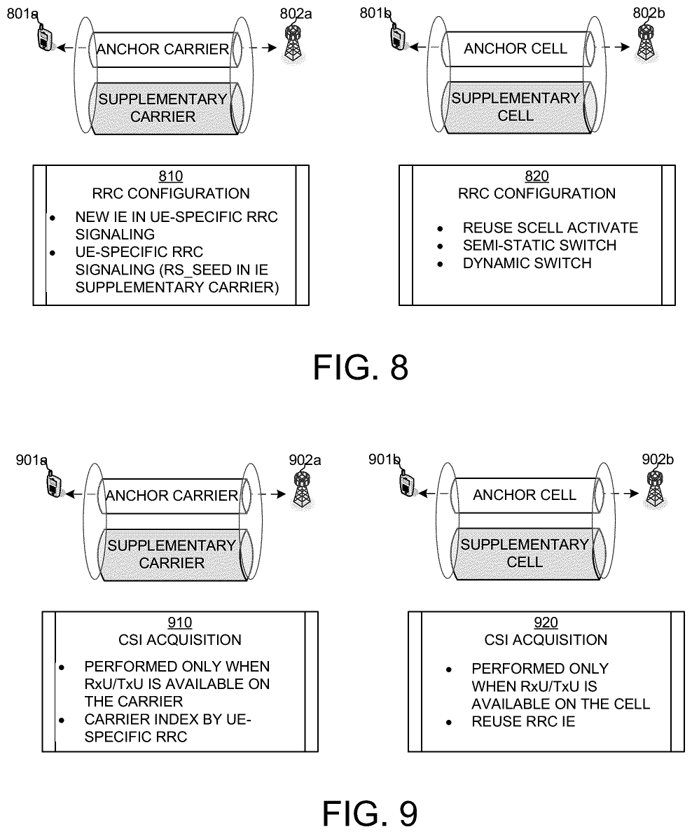

FIG. 8 illustrates exemplary diagrams for RRC configurations for SUL-based and CA-based carrier switches in accordance with embodiments of the current invention. For the SUL-based framework, UE 801a establishes connection with gNB 802a with anchor carrier and is configured with supplementary carrier for SUL-based TxRU carrier switch. For the CA-based framework, UE 801b establishes connection with gNB 802b with anchor carrier and is configured with supplementary cell for CA-based TxRU carrier switch.

In one embodiment 810 for the SUL-based RRC structure, a new IE is introduced in the UE-specific RRC signaling. In one embodiment, to support TxRU carrier switch, new IE ‘supplementaryCarrierConfig’ is introduced in servingCellConfig through UE-specific RRC signaling.

ServingCellConfig ::= SEQUENCE {
tdd-UL-DL-ConfigurationDedicated TDD-UL-DL-ConfigDedicated OPTIONAL
initialDownlinkBWP BWP-DownlinkDedicated OPTIONAL
downlinkBWP-ToReleaseList SEQUENCE (SIZE (1..maxNrofBWPs)) OF BWP-Id
OPTIONAL
downlinkBWP-ToAddModList SEQUENCE (SIZE (1..maxNrofBWPs)) OF BWP-Downlink
OPTIONAL
firstActiveDownlinkBWP-Id BWP-Id OPTIONAL
...
supplementaryCarrierConfig supplementaryCarrier OPTIONAL
}

One or more of parameters are configured for supplementary carriers.

supplementaryCarrier ::= SEQUENCE {
CarrierIndex (Note: value > 0; 0 is reserved for anchor carrier)
physCellId (Note: can be renamed as RS_seed) PhysCellId OPTIONAL
downlinkConfigCommon DownlinkConfigCommon OPTIONAL
uplinkConfigCommon UplinkConfigCommon OPTIONAL
n-TimingAdvanceOffset ENUMERATED { n0, n25600, n39936 } OPTIONAL (Note: (a)
absent or same value as anchor carrier if configured, or (b) remove it)
dmrs-TypeA-Position ENUMERATED {pos2, pos3}
tdd-UL-DL-ConfigurationCommon TDD-UL-DL-ConfigCommon OPTIONAL (Note:
necessary if TDD & inter-band carrier)
tdd-UL-DL-ConfigurationDedicated TDD-UL-DL-ConfigDedicated OPTIONAL (Note:
necessary if TDD & inter-band carrier)
lte-CRS-ToMatchAround SetupRelease { RateMatchPatternLTE-CRS } OPTIONAL
rateMatchPatternToAddModList SEQUENCE (SIZE (1..maxNrofRateMatchPatterns)) OF
RateMatchPattern OPTIONAL
rateMatchPatternToReleaseList SEQUENCE (SIZE (1..maxNrofRateMatchPatterns)) OF
RateMatchPatternId OPTIONAL
ssb-PositionsInBurst CHOICE {
shortBitmap BIT STRING (SIZE (4)),
mediumBitmap BIT STRING (SIZE (8)),
longBitmap BIT STRING (SIZE (64))
} OPTIONAL
ssb-periodicityServingCell ENUMERATED { ms5, ms10, ms20, ms40, ms80, ms160,
spare2, spare1 } OPTIONAL
ssbSubcarrierSpacing SubcarrierSpacing OPTIONAL
ss-PBCH-BlockPower INTEGER (−60..50)
firstActiveDownlinkBWP-Id BWP-Id OPTIONAL
defaultDownlinkBWP-Id BWP-Id OPTIONAL
downlinkBWP-ToReleaseList SEQUENCE (SIZE (1..maxNrofBWPs)) OF BWP-Id
OPTIONAL
downlinkBWP-ToAddModList SEQUENCE (SIZE (1..maxNrofBWPs)) OF BWP-Downlink
OPTIONAL
uplinkConfig UplinkConfig OPTIONAL
pdcch-ServingCellConfig SetupRelease { PDCCH-ServingCellConfig } OPTIONAL
pdsch-ServingCellConfig SetupRelease { PDSCH-ServingCellConfig } OPTIONAL
csi-MeasConfig SetupRelease { CSI-MeasConfig } OPTIONAL
tag-Id TAG-Id (Note: same ID as anchor carrier if configured)
dummy ENUMERATED {enabled} OPTIONAL
pathlossReferenceLinking ENUMERATED {spCell, sCell} OPTIONAL
...,
}

Further, for supplementary carrier, N_{ID}^{cell} is configured by UE-specific RRC signaling (e.g. RS_seed in IE supplementary carrier).

In another embodiment 820 for the CA-based RRC structure, the supplementary cell is activated or deactivated by reusing the Scell procedures. In one embodiment, the RRC IE, such as the servingCellConfig is used. The UE does not need to receive or transmit data on anchor cell and supplementary cell simultaneously. The inter-band and/or the intra-band switch is configured semi-static or dynamically configured. If dynamic carrier switch is supported, the UE reuses the CIF field or introduces an additional field in DCI to indicate which cell is switched to. For example, an additional field of one bit is used to indicate which carrier/cell is switched to.

FIG. 9 illustrates exemplary diagrams for CSI acquisition for SUL-based and CA-based carrier switch in accordance with embodiments of the current invention. For the SUL-based framework, UE 901a establishes connection with gNB 902a with anchor carrier and is configured with supplementary carrier for SUL-based TxRU carrier switch. For the CA-based framework, UE 901b establishes connection with gNB 902b with anchor carrier and is configured with supplementary cell for CA-based TxRU carrier switch.

In one embodiment 910 of SUL-based TxRU carrier switch, for CSI acquisition of supplementary carrier, CSI-RS reception/measurement of sound reference signal (SRS) transmission is performed only when RxU/TxU is available on the carrier. Otherwise, additional TxRU switch may be needed for RS transmission or reception, and priority rule may be needed to handle the DL/UL slot collision on the anchor carrier and the supplementary carrier. The measurement can be based on periodic, semi-periodic, or aperiodic CSI-RS resources on the supplementary carrier. In another embodiment, the carrier index is provided by UE-specific RRC signaling for CSI-RS resource association, such as indicate which carrier that CSI-RS resource is transmitted on. In one embodiment, a new RRC parameter is used. In another embodiment, the ‘carrier’ field is reused with new interpretation. For example, when supplementary carrier is configured, ‘carrier’ is used to indicate in which carrier the CSI-ResourceConfig indicated is to be used. In one embodiment, if the ‘carrier’ field is absent, the resources are on the same serving cell as this report configuration.

In one embodiment 920 of CA-based TxRU carrier switch, for CSI acquisition of supplementary carrier, CSI-RS reception/measurement of sound reference signal (SRS) transmission is performed only when RxU/TxU is available on the carrier. Otherwise, additional TxRU switch may be needed for RS transmission or reception, and priority rule may be needed to handle the DL/UL slot collision on the anchor carrier and the supplementary carrier. The measurement can be based on periodic, semi-periodic, or aperiodic CSI-RS resources on the supplementary carrier. In one embodiment, for CSI acquisition of the anchor cell, the CSI-RS reception/measurement or SRS transmission is prioritized. For example, TxRU is switched if CSI-RS reception or SRS transmission is needed. In another embodiment, CSI-RS reception/measurement or SRS transmission is performed only when RxU/TxU is available on the anchor cell. In one embodiment, RRC IE (carrier index) for CSI-RS resource association is reused to indicate which cell the CSI-RS resource is transmitted on.

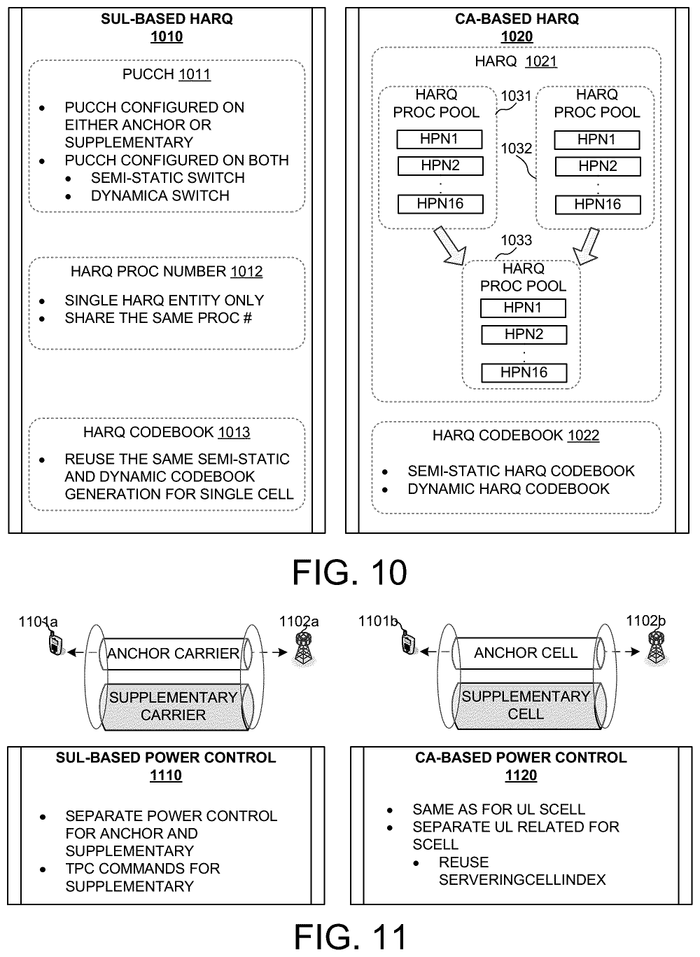

FIG. 10 illustrates exemplary diagrams for HARQ configuration for SUL-based and CA-based carrier switches in accordance with embodiments of the current invention. In one embodiment 1010 SUL-based HARQ configuration are provided. In one embodiment 1011, PUCCH resources are configured for HARQ-ACK information feedback for the TxRU carrier switch. In one embodiment, the PUCCH carrier is configured on either the anchor carrier or the supplementary carrier. In another embodiment, the PUCCH carrier is configured on both the anchor carrier and the supplementary carrier with semi-static switch or dynamic switch. For the semi-static switch, the carrier to transmit PUCCH is determined by the configuration of TxRU semi-static switch pattern, or by the TxU if TxU and RxU are configured with separate switch pattern. In another embodiment, separate switch patterns are configured TxU switch and the PUCCH carrier switch. The UE switches TxU for PUCCH transmission by following PUCCH carrier switch pattern. For the dynamic switch configuration, the carrier to transmit the PUCCH is indicated by DCI, such as DCI format 1_0 and/or 1_1. In one embodiment, if the TxU switch is explicitly indicated in the DCI, the indication is reused to indicate PUCCH carrier switch. If the TxU switch is implicitly indicated in DCI, such as indicated by PUSCH scheduled carrier, there can be a separate DCI indication for PUCCH carrier switch. For example, the PUCCH is transmitted on the anchor carrier if it is ‘0’; while the PUCCH is transmitted on the supplementary carrier if it is ‘1’. In one embodiment 1012, the HARQ process number is configured for TxRU carrier switch. In one embodiment, a single HARQ entity is configured. In another embodiment, the anchor carrier and the supplementary carrier share the same HARQ process number. In another embodiment 1013, HARQ codebook is configured for TxRU carrier switch. In one embodiment, the HARQ codebook reuses the same semi-static and dynamic codebook generation for single cell.

In one embodiment 1020 CA-based HARQ configuration is provided. In one embodiment 1021, a common HARQ process pool for the anchor cell and the supplementary cell are configured. As illustrated HARQ process pool 1031 for the anchor cell and the HARQ process pool 1032 for the supplementary cell are combined/configured to a common HARQ process pool 1033 for the anchor cell and the supplementary cell. The HARQ process is shared between the anchor cell and the supplementary cell. For example, for new transmission for HARQ process #1 at the anchor cell, NDI is toggle and RV=0. Retransmission for HARQ process #1 at the supplementary cell NDI is not toggled and RV=2. In one embodiment, the maximum number of HARQ process is equal to the maximum number of HARQ process for a carrier. In one embodiment, the PUCCH resource for the CA-based TxRU carrier switch is the same as the SUL-based TxRU carrier switch as illustrated in 1011. In one embodiment 1022, semi-static codebook or dynamic codebook is configured for the CA-based TxRU carrier switch. In one embodiment for the semi-static HARQ codebook configuration, the NR HARQ codebook for CA is reused. In another embodiment for the semi-static HARQ codebook configuration, the codebook is configured with no cell/carrier dimension. The same K1 configuration is used for both the anchor cell and the supplementary cell.

FIG. 11 illustrates exemplary diagrams for UL power control for SUL-based and CA-based carrier switch in accordance with embodiments of the current invention. For the SUL-based framework, UE 1101a establishes connection with gNB 1102a with anchor carrier and is configured with supplementary carrier for SUL-based TxRU carrier switch. For the CA-based framework, UE 1101b establishes connection with gNB 1102b with anchor carrier and is configured with supplementary cell for CA-based TxRU carrier switch.

In one embodiment 1110, SUL-based power control configuration is provided. In one embodiment, separate UL power control related configuration is configured for the anchor carrier and the supplementary carrier. In one embodiment, TPC commands in DCI format 2_2 for supplementary carrier is provided. UE-specific RRC signaling is used to configure the first position of TPC command for supplementary carrier. The UE acquires corresponding TPC command bits for supplementary carrier based on its bit position. In one embodiment, for type-1 power headroom report, the UL carrier for reference PUSCH transmission is determined based on the following rules. If only one UL carrier is configured with pusch-config: the UE computes a Type-1 PHR for the serving cell assuming a reference PUSCH transmission on the UL carrier provided by pusch-Config; if the UE is provided pusch-Config for more than one UL carrier and if only one UL carrier is configured w/pucch-Config: the UE computes a Type-1 PHR for the serving cell assuming a reference PUSCH transmission on the UL carrier provided by pucch-Config; if no UL carrier is configured with pucch-Config or more than one UL carrier is configured with pucch-Config: the UE computes a Type-1 PHR for the serving cell assuming a reference PUSCH transmission on anchor carrier. In one embodiment for type-3 power headroom report, the UL carrier for reference SRS transmission is determined based on the following rules: If only one UL carrier is configured w/pucch-Config: the UE computes a Type 3 PHR for the serving cell assuming a reference SRS transmission on the UL carrier provided by pucch-Config; if no UL carrier is configured w/pucch-Config or more than one UL carrier is configured w/pucch-Config, the UE computes a Type 3 PHR for the serving cell assuming a reference SRS transmission on the anchor carrier.

In one embodiment 1120, CA-based framework for power control configuration is provided. In one embodiment, the CA-based framework uses the same UL power control procedures as for the SCell. In another embodiment, separate UL power control related configuration are configured for SCell. The servingcellindex is reused to indicate TPC commands in DCI format 2_2 for the supplementary cell.

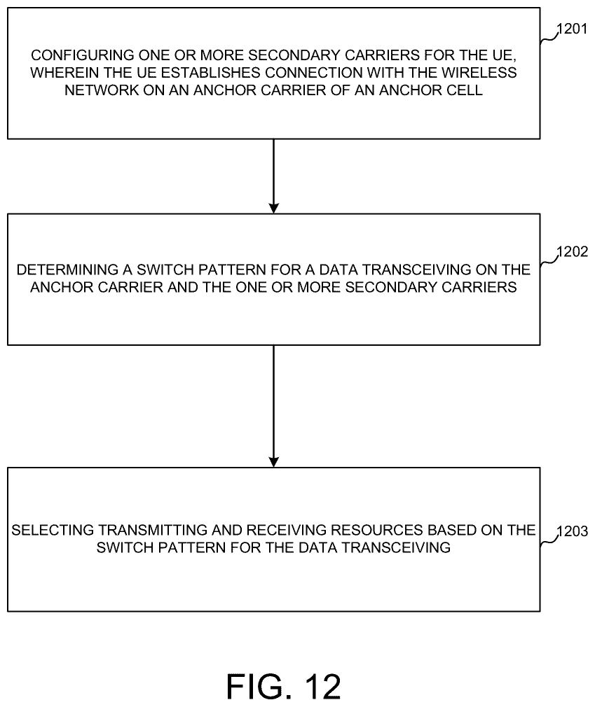

FIG. 12 illustrates an exemplary flow chart for the TxRU carrier switch in accordance with embodiments of the current invention. At step 1201, the UE configures one or more secondary carriers for the UE, wherein the UE establishes connection with the wireless network on an anchor carrier of an anchor cell. At step 1202, the UE determines a switch pattern for a data transceiving on the anchor carrier and the one or more secondary carriers. In one embodiment, the UE is a reduced capability (RedCap) UE that the TxU transmits on one carrier at a time and the RxU receives on one carrier at a time. At step 1203, the UE selects transmitting and receiving resources based on the switch pattern for the data transceiving.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) with a transmitter unit (TxU) and a receiver unit (RxU) of a transceiving unit (TxRU) in a wireless network comprising:
configuring one or more secondary carriers for the UE, wherein the UE establishes connection with the wireless network on an anchor carrier of an anchor cell;
determining a switch pattern for a data transceiving on the anchor carrier and the one or more secondary carriers; and
selecting transmitting and receiving resources based on the switch pattern for the data transceiving.

2. The method of claim 1, wherein the switch pattern is semi-static, and wherein the semi-static switch pattern is configured by a UE-specific radio resource control (RRC) signaling for each carrier, derived from a time divisional duplex (TDD) configuration for each carrier, or determined by a TxRU hopping formula.

3. The method of claim 1, wherein the switch pattern is dynamically configured through downlink control information (DCI).

4. The method of claim 1, wherein the switch pattern is configured in a hybrid mode for the TxU and the RxU with a combination of a semi-static switch pattern and a dynamic switch pattern.

5. The method of claim 1, further comprising: configuring one or more switch gaps along with each TxU or RxU carrier switch based on the switch pattern, wherein there is no data transceiving during each switch gap.

6. The method of claim 5, wherein TxRU switch gap locations are configured separately for the TxU and the RxU.

7. The method of claim 5, wherein joint switch gap locations are configured for the TxU and the RxU, and wherein each carrier is configured with joint switch pattern and gap location in slot or symbol level, or a combination of slot and symbol level.

8. The method of claim 1, wherein the one or more secondary carriers are supplementary carriers of the anchor cell.

9. The method of claim 8, wherein the anchor carrier is TDD carrier or frequency division duplex (FDD) carrier, and wherein the supplementary carrier is configured as a TDD carrier, a FDD carrier, a supplementary uplink carrier (SUL), or a supplementary downlink carrier (SDL).

10. The method of claim 1, wherein the one or more secondary carriers are supplementary cells different from the anchor cell.

11. The method of claim 10, wherein the supplementary cells are activated with MAC control element (CE).

12. A user equipment (UE), comprising:
a transceiving unit (TxRU), including a transmitter unit (TxU) and a receiver unit (RxU), that transmits and receives radio frequency (RF) signals in a wireless network;
a configuration module that configures one or more secondary carriers for the UE, wherein the UE establishes connection with the wireless network on an anchor carrier of an anchor cell;
a switch pattern module that determines a switch pattern for a data transceiving on the anchor carrier and the one or more secondary carriers; and
a transceiving controller that selects transmitting and receiving resources based on the switch pattern for the data transceiving.

13. The UE of claim 12, wherein the switch pattern is semi-static, and wherein the semi-static switch pattern is configured by a UE-specific radio resource control (RRC) signaling for each carrier, derived from a time divisional duplex (TDD) configuration for each carrier, or determined by a TxRU hopping formula.

14. The UE of claim 12, wherein the switch pattern is dynamically configured through downlink control information (DCI).

15. The UE of claim 12, wherein the switch pattern is configured in a hybrid mode for the TxU and the RxU with a combination of a semi-static switch pattern and a dynamic switch pattern.

16. The UE of claim 12, further comprising a switch gap module that configures one or more switch gaps along with each TxU or RxU carrier switch based on the switch pattern, wherein there is no data transceiving during each switch gap.

17. The UE of claim 16, wherein TxRU switch gap locations are configured separately for the TxU and the RxU, or each carrier is configured with joint switch pattern and gap location in slot or symbol level, or a combination of slot and symbol level.

18. The UE of claim 12, wherein multiple bandwidth parts (BWPs) are configured for one or more carriers comprising the anchor carrier and the one or more secondary carriers, and wherein a BWP is selected for each carrier the TxRU switched to based on a criterion selecting from through a BWP linkage based on BWP ID, through a predefined BWP, and through a BWP hopping.

19. The UE of claim 12, wherein the one or more secondary carriers are supplementary carriers of the anchor cell, and wherein the anchor carrier is TDD carrier or frequency division duplex (FDD) carrier, and wherein the supplementary carrier is configured as a TDD carrier, a FDD carrier, a supplementary uplink carrier (SUL), or a supplementary downlink carrier (SDL).

20. The UE of claim 12, wherein the one or more secondary carriers are supplementary cells different from the anchor cell, and wherein the supplementary cells are activated with MAC control element (CE).
